(19) United States
(12) Patent Application Publication
(10) Pub. No.: US 2010/0289267 A1
(43) Pub. Date: Nov. 18, 2010

(54) INTEGRATED POWER SYSTEM COMBINING TIDAL POWER GENERATION AND OCEAN CURRENT POWER GENERATION

(76) Inventors: Kyung Soo Jang, Seoul (KR); Jung Eun Lee, Seoul (KR); Jae Won Jang, Seoul (KR); Seung Won Jang, Seoul (KR)

Correspondence Address: BIRCH STEWART KOLASCH & BIRCH, PO BOX 747, FALLS CHURCH, VA, 22040-0747, US

(21) Appl. No.: 12/812,716

(22) PCT Filed: Mar. 12, 2008
(86) PCT No.: PCT/KR2008/001388

§ 371 Date: Jul. 13, 2010

(30) Foreign Application Priority Data
Jan. 30, 2008 (KR) 1020080009383

(51) Int. Cl. F03B 13/26

(52) U.S. Cl. 290/53

(57) ABSTRACT

An integrated power system combining tidal power generation and ocean current power generation comprises: constructing barrages across the sea to make up a lake; installing turbine structures of a tidal power plant and sluice structures of a tidal power dam for generating electricity by using the potential energy difference between seawaters caused by tides and ebbs; forming an ocean current power park in a lake side by installing a plurality of ocean current generators, for generating electricity by using the flow of the seawater discharged through turbine generators, in a rear lake side of the turbine structures of the tidal power plant; and forming an ocean current power park in a sea side by installing ocean current generators, for generating electricity by using the seawater with the fast speed discharged into the sea through sluice gates, in a rear sea side of the sluice structures of the tidal power dam.

### TECHNICAL FIELD

The present invention relates to an integrated power system combining tidal power generation and ocean current power generation, and more particularly, to an integrated power system combing a tidal power plant and ocean current power parks, which is capable of increasing the operating rate of power facilities and efficiently generating electrical energy by using the incoming seawater into a lake through turbine generators of a tidal power plant or the fast flow of the seawater discharged to a sea side through sluice gates of a tidal power dam, and which is particularly connected with a tidal power plant for generating electricity by using the potential energy difference between seawaters caused by tides and ebbs.

### BACKGROUND ART

The present invention relates to tidal power generation and tidal current power generation among ocean energy resources. The tidal power generation is a means of generating electricity by using the potential energy difference existing between seawaters, which move due to tides, and may be divided into: a single lagoon and multi lagoons depending on the number of lakes or lagoons surrounded by barrages; a single flow type and a double flow type depending on the direction of flow; and a flooding type and an ebbing type depending on tides to be used when generating electricity.

The tidal power plant on construction in Siwha lake, west coast line in south Korea adopts a flooding type generation method to keep high water levels in the outside sea and low water levels in a lake side when generating electricity because the water levels of the outside sea based on the barrages changes by several meters up and down depending on the time based on managing levels, whereas water levels of lagoon must be kept under the managing level.

The power output obtainable from a tidal power generation is proportional to the efficiency of a turbine generator, the cross sectional area of a seawater passage and 3/2 power of the difference between sea levels of the sea and the lake caused by tides and ebbs, and therefore, a highly efficient turbine generator, a generator having large blade, and large difference between sea levels by tides and ebbs result in high economical efficiency.

Tidal current power generation, which is another generating method closing to the commercialization among the ocean energy resources, is a generating method, which installs turbine generators in the place where tidal current is flowing fast, and extracts electricity from the kinetic energy of current. The tidal current power generation using the tidal current is involved in ocean current power generation in terms of broad meaning and classified into: Helical type, HAT (Horizontal Axis Turbine) type and VAT (Vertical Axis and Turbine) type depending on the type of turbine generators; and floating type and attaching type to bottom depending on installation methods of turbine generators.

The tidal power generation artificially forms barrages and generates electricity by using the head drop of seawater in the inner side and outer side of the barrages. However, the ocean current power generation generates electricity by installing the turbine generators in a corner of ocean currents, which naturally flow. The theoretical principles of ocean current power generation is similar to that of wind power generation but is different from the wind power generation to rotate turbines by using ocean currents, which flow on, instead of the wind. In case of the ocean current power generation, the density (power/area) thereof is larger about 4 times than that of wind power because the density of seawater is larger about 840 times compared with the density of air. Thus, in the same equipment capacity, ocean current power generators are far smaller compared with wind power generators.

The power output obtainable from ocean current power generation is proportional to the efficiency of turbine generators, the cross sectional area of an ocean current passage and 3 power of the ocean current velocity. Therefore, the high ocean current velocity is absolutely advantageous for ocean current power generation.

Tidal and ocean current energies have the advantages such that: the energies are infinite, clean energy originating from the universal gravitation among the sun, the moon, and the earth which continues as long as the solar system exists; the energies are not affected by weather or season due to the periodicity of the flowing and ebbing tides; long-term prediction of generation output is possible; it is possible to supply power continuously for a certain period of time; and it is easy to connect within a power network. On the other hand, its disadvantages include sporadic generation and large initial investment due to the construction of power transmission lines if the power plant is far from land.

Until recently, the applicability of ocean current power generation was considered if the average ocean current speed was fast, i.e., typically at least 2 m/s in the high current cycle, in narrow straits between islands and land. However, while several tidal power plants have been practically applied, one example of large-scale ocean current power generation is rare in the world. The reason for this is that it was not easy to find a proper site on which to install a turbine generator due to the lack of natural sea areas where the seawater flow is fast enough for current power generation. Furthermore, even if the average ocean current speed were satisfactory, it is difficult to achieve the structural stability of the turbine generator and reliable control of generation volume if the speed distribution is uneven according to the seabed topography of the area where a current power plant is to be installed.

In general, the average velocity of natural ocean currents for ocean current power generation must be 2.0 to 2.5 m/s, which is greatly affected by seabed topography and the frequent change of flow direction. However, ocean currents that can be obtained from a tidal power plant include more even kinetic energy, which has higher utility value than the natural ocean current condition. In the case that the Sihwa Lake Tidal Power Plant, which adopts a single flow flooding type, generates electricity with the head drop of 6.0 m at high tide, it is examined that the average velocity of the water discharged to the lake after passing through turbine generators is at least 3.0 m/s and the average velocity of the seawater discharged to the sea through a sluice conduit is at least 6.0 m/s.

### DISCLOSURE OF INVENTION

### Technical Problem

In contrast to ocean current power generation, which uses the natural flow of seawater, the seawater, which passes through turbine generators of a tidal power plant and sluice gates of a tidal power dam, is high-quality seawater which flows in a fixed direction at a predictable speed, and it is easy to control generation volume. In particular, if a tidal power plant is simultaneously constructed with ocean current power parks, the construction cost could be saved and higher economic effects could be obtained than it is constructed alone.

Accordingly, in consideration of the above circumstances, the present invention has been made and an object of the present invention is to provide an integrated power system combining tidal power and ocean current power, which is capable of increasing the operating rate of power facilities and efficiently generating electrical energy by using incoming seawater into the lake through turbine generators of the tidal power plant or the fast flow of the seawater discharged to a sea side through the sluice gates of the tidal power dam. A further object of the present invention arranges ocean current generators to enhance the energy density to unit area in consideration of characteristics of ocean currents, which pass through the turbine generators of the tidal power plant and the sluice conduits of the tidal power dam.

### Technical Solution

To accomplish the above objects, the present invention is characterized by constructing barrages across the sea to make up a lake or a lagoon; installing turbine structures of a tidal power plant and sluice structures of a tidal power dam, for generating electricity by using the potential energy difference of seawater caused by tides and ebbs, between the barrages; installing turbine generators for generating electricity by rotating a turbine blade, using the flow of the incoming seawater into a lake side from a sea side when flooding in the turbine structures; installing sluice gates, for closing and opening a sluice conduit when flooding and ebbing, in the sluice structures; forming an ocean current power park in the lake side by installing a plurality of ocean current generators, for generating electricity by using the flow of the seawater discharged through the turbine generators, in a rear lake side of the turbine structures of the tidal power plant; and forming an ocean current power park in the sea side by installing a plurality of ocean current generators, for generating electricity by using the flow of the seawater with the fast speed discharged into the sea through the sluice gates, in a rear sea side of the sluice structures of the tidal power dam.

A plurality of ocean current generators installed in the rear lake side of the turbine structures of the tidal power plant and in the rear sea side of the sluice structures of the tidal power dam are arranged in a cross shape having a predetermined space between lines so that even number line and odd number line of the generators cross each other.

The plurality of ocean current generators installed in the rear lake side of the turbine structures of the tidal power plant and in the rear sea side of the sluice structures of the tidal power dam are installed at a mono file on the seabed, respectively.

The turbine structures of the tidal power plant and the sluice structures of the tidal power dam are connected to each other with connection structures or connection barrages therebetween.

At least one or more turbine structures of the tidal power plant and sluice structures of the tidal power dam are connected each other, respectively.

### EFFECTS OF THE INVENTION

An integrated power system combining tidal power generation and ocean current power generation of the present invention may increase the operating rate of power facilities by using incoming seawater into the lake through turbine generators and the fast flow of the seawater discharged into the sea through sluice gates.

Further, ocean currents that pass through the turbine generators of a tidal power plant or the sluice gates of a tidal power dam occur kinetic energy which has higher utility value than the natural ocean current condition, and accordingly, ocean current generators can produce larger electricity.

The ocean currents that pass through the turbine generators of the tidal power plant or the sluice gates of the tidal power dam is high-quality seawater which flows in a fixed direction at a predictable speed, and it is easy to control generation volume.

In particular, if a tidal power system is simultaneously constructed with ocean current power parks, the construction cost could be saved and higher economic effects could be obtained compared with the construction of an ocean current power park only.

Moreover, the extraction of kinetic energy from the ocean currents with high velocity that pass through the turbine generators of the tidal power plant and the sluice gates of the tidal power dam by the ocean current generators slows down the speed of ocean currents, and can relieve a considerable part of the impact on ocean ecosystem and natural environment caused by the tidal power generation. Therefore, ocean current power generation connected with tidal power generation can create a more environmentally-friendly integrated power system capable of complementing the shortcomings of tidal power generation.

### BRIEF DESCRIPTION OF DRAWINGS

The accompanying drawings illustrate example embodiments of the present invention. Example embodiments may, however, be embodied in different forms and should not be considered as limited to the embodiments set forth in the drawings.

FIG. 1 is a plane view illustrating an integrated power system combining a tidal power plant, a tidal power dam and two ocean current power parks according to an embodiment of the present invention;

FIG. 2 is a side view illustrating turbine structures of a tidal power plant and an ocean current power park in a lake side according to an embodiment of the present invention; and

FIG. 3 is a side view illustrating sluice structures of a tidal power dam and an ocean current power park in a sea side according to an embodiment of the present invention.

### BEST MODE FOR CARRYING OUT THE INVENTION

Hereinafter, embodiments of the present invention will now be described in greater detail with reference to the accompanying drawings.

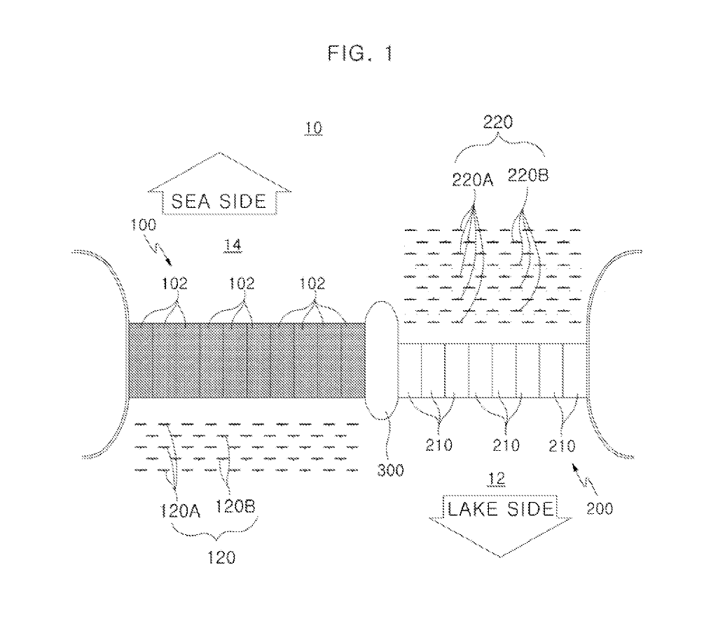

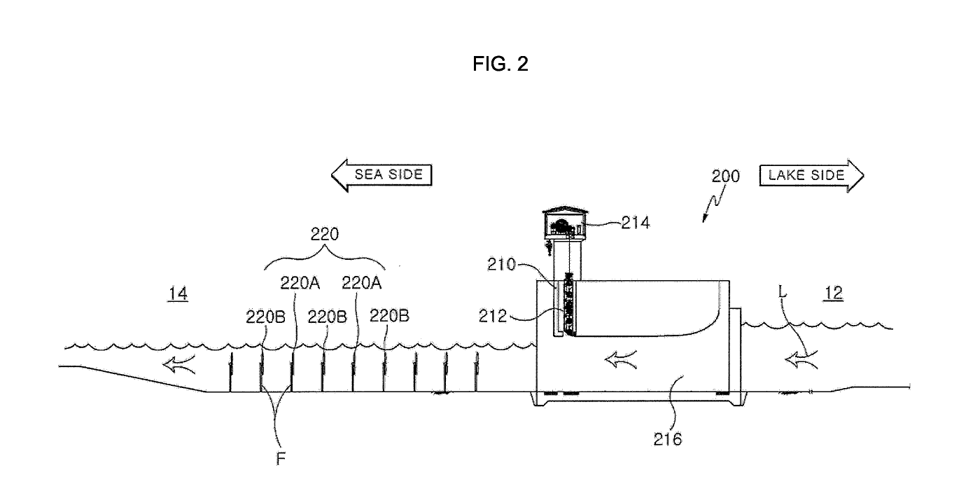

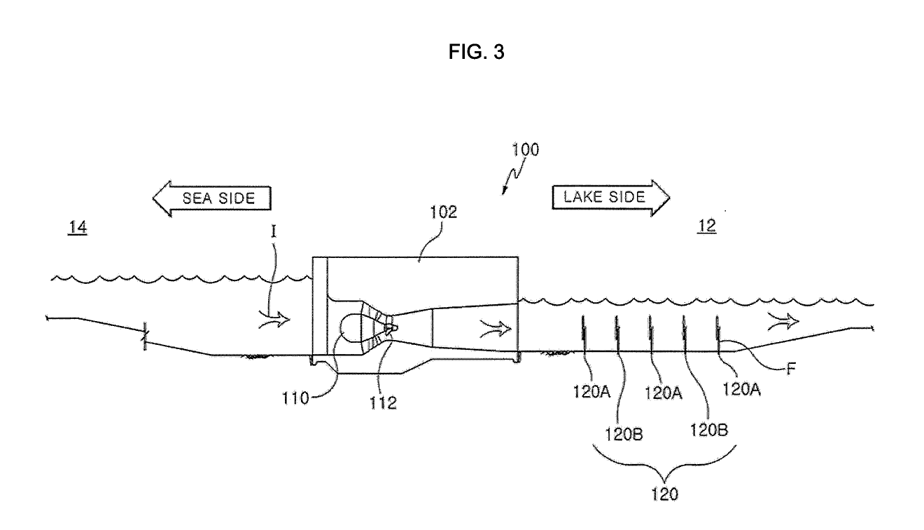

FIG. 1 is a plane view illustrating an integrated power system combining a tidal power plant, a tidal power dam and two ocean current power parks according to an embodiment of the present invention; FIG. 2 is a side view illustrating turbine structures of a tidal power plant and an ocean current power park in a lake side according to an embodiment of the present invention; and FIG. 3 is a side view illustrating sluice structures of a tidal power dam and an ocean current power park in a sea side.

As illustrated in FIG. 1, the integrated power system combining a tidal power plant, a tidal power dam and two ocean current power parks according to the present invention needs to construct a barrage 10 in the place where a large difference between tides and ebbs occurs.

After the barrage 10 as described above is constructed, a lake 12 is formed as shown in FIG. 1. In the barrage 10, the tidal power plant 100 and the tidal power dam 200 across between a lake side 12 and a sea side 14 are installed.

Preferably, the tidal power plant 100 and the tidal power dam 200 are connected to each other with a connection structure 300 or a connection barrage therebetween.

The connection structure 300 or the connection barrage can be established with hundreds or thousands of meters according to characteristics of topography.

As illustrated in FIG. 2, turbine generators 110 having a turbine blade 112, which rotate by the flow of the incoming seawater into the lake side 12, are installed within turbine structures 102 which form the tidal power plant 100.

The turbine structures 102, which form the tidal power plant 100, are illustrated such that ten turbine structures in one unit body are connected each other as shown in FIG. 1. However, it is not limited to that and the installation number thereof may be modified according to topography characteristics or a plan of generation volume.

A plurality of ocean current generators 120, which generate electricity by using the flow of the seawater discharged through the turbine generator 110, is installed in the back direction of the turbine structures 102 of the tidal power plant 100, namely, a lake side 12, thereby forming an ocean current power park in the lake side 12.

The plurality of ocean current generators 120 are arranged in cross shape with a predetermined space between lines as much as the diameter of the turbine blade of the ocean current generators 120 as illustrated in FIGS. 1 and 2 and an ocean current generator 120A in even number line and ocean current generator 120B in odd number line are arranged to be cross each other.

Moreover, when the ocean current generators 120 are arranged in the lake side 12, the installation number of the ocean current generators 120 to a unit area may be increased by narrowing arrangement spaces in a perpendicular direction to the flow direction of seawater, according as the speed of ocean currents become fast. In particular, as conditions of the present invention, in the case that the speed of ocean currents discharged from the turbine structures 102 of the tidal power plant 100 is 3.0 m/s or more and the flow of seawater is good, the ocean current generators 120 in the lake side 12 may be arranged with more narrow space than the diameter of the turbine blade.

Meanwhile, regarding the ocean current generators 120 in the lake side 12, preferably, the distance between the ocean current generator 120A to be firstly disposed in the odd number line and the turbine structures 102 is about the size of a way out of the turbine structures 102. For this reason, when the seawater passes through the turbine generators 110 and flows into the lake, its becomes turbulent, and therefore, the ocean current generator 120A to be firstly disposed in the odd number line is arranged in the place where the flow of the seawater becomes stable due to the reduction of turbulent. As the result, the structural stability of the ocean current generator 120A is secured and the generation is stably performed.

Sluice gates 212 are installed in sluice structures 210, which forms a tidal power dam 200 as illustrated in FIG. 3. When flooding, the sluice gates 212 drop by a winding device 214, thereby preventing that the seawater in a sea side 14 flows to the lake side 12 and when ebbing, the sluice gates rise, thereby discharging the seawater in the lake side 12 to the sea side 14 through a sluice conduit 216.

The sluice structures 210, which form the tidal power dam 200, are arranged with eight sluice structures 210 in one unit body as shown in FIG. 1, but it is not limited to that and the installation number may be modified according to topography characteristics of the ocean current power park or a plan of generation volume.

Ocean current generators 220, which generate electricity by using the seawater with the fast speed discharged to the sea through the sluice gates 212, are installed in the back direction of the sluice gates 212 of the sluice structures 210 of the tidal power dam 200, namely, the sea side 14 as shown in FIGS. 1 and 3. The plurality of ocean current generators 220 are installed in the sea side 14, thereby forming an ocean current power park in the sea side.

Preferably, the plurality of ocean current generators 220 are arranged in cross shape with a predetermined space between lines as much as the diameter of the turbine blade of the ocean current generators and the ocean current generator 220A in the even number line and the ocean current generator 220B in odd number line are arranged to be cross each other.

Moreover, when the ocean current generators 220 are arranged in the lake side 12, the more the speed of ocean currents is fast, the installation number of the ocean current generators 120 to a unit area may be increased by narrowing arrangement spaces in a perpendicular direction to the flow direction of seawater according to fast speed of ocean currents. In particular, as the condition of the present invention, in the case that the speed of ocean currents discharged through the sluice gates 212 is 6.0 m/s or more and the flow of seawater is good, the ocean current generators may be arranged with about ½ more narrow space than the diameter of the turbine blade.

At here, the ocean current generators 120 in the lake side and the ocean current generators 220 in the sea side are supported by and installed at a monofile (F), which stands on the seabed, respectively.

Moreover, the ocean current generators 120 in the lake side and the ocean current generators 220 in the sea side 14 include a propeller, which is rotated and driven by the flow of ocean currents, and generators having a rotor connected to a rotational axis of the propeller.

At least one or more the turbine structures 102 of the tidal power plant 100 and the sluice structures 210 of the tidal power dam 200 are connected, respectively, as shown in FIG. 1.

Meanwhile, regarding the ocean current generators 220 in the sea side 14, preferably, the distance between the ocean current generator 220A to be firstly disposed in the odd number line and the sluice structures 210 is about the size of a way out of the sluice structures 210.

In the example embodiment, when the ocean current power park is formed through the ocean current generators 120, 220 according to topography characteristics or a plan of generation volume of the tidal power plant 100 and tidal power dam 200, an integrated generation system combining tidal power generation and ocean current generation may be formed by: installing the plurality of ocean current generators 120, 220 only in the lake side 12 of the tidal power plant 100; installing the plurality of ocean current generators 120, 220 only in the sea side 14 of the tidal power dam 200; and installing the plurality of ocean current generators 120, 220 in all of the lake side 12 of the tidal power plant 100 and the sea side 14 of the tidal power dam, respectively as shown in FIG. 1.

The effects of the example embodiment as described above will be explained.

The sluice gates 212 installed in the sluice structures 210 of the tidal power dam are closed when flooding that seawater flows into the lake side 12 from the sea side 14. Accordingly, the seawater in the sea side 14 flows into the lake side 12 as an arrow direction in FIG. 2.

Accordingly, the turbine blade 112 of the turbine generators 110 installed in the turbine structures 102 of the tidal power plant 100 are rotated by the flow of ocean currents and the turbine generators 110 produce electricity. The incoming seawater into the lake side 12 after passing through the turbine generators 110 passes through the plurality of ocean current generators 120 in the lake side. At this time, the average speed of the seawater is 3.0 m/s or more. Thus, ocean current generation is accomplished from the plurality of ocean current generators 120 arranged in the cross shape with a space less than the diameter of the turbine blade of the ocean current generators 120 in the lake side. The ocean current generation is continued until the water level of the lake reaches the managing level and the turbine generators 110 of the tidal power plant 100 stops to generate electricity when the water level of the lake reaches the managing level and this stop state is kept until the water level of the sea side becomes lower than that of the lake side by ebbing.

Meanwhile, when the water level of the sea side 14 becomes lower than that of the lake side by ebbing after flooding, the sluice gates 212 in the sluice structures 210 of the tidal power dam are opened as shown in FIG. 3 and the seawater in the lake side 12 is discharged to the sea side 14 as the arrow direction through the sluice conduit 216. At this time, the average speed of seawater discharged through the sluice gates 212 is 6.0 m/s or more and the plurality of ocean current generators 220, which go through the tidal power dam 200 and is installed in the sea side 14, are driven, thereby producing electricity.

The integrated generation system combining tidal power generation and ocean current generation according to the present invention generates electricity by using all of the incoming seawater into the lake side 12 from the sea side 14 and the seawater discharged to the sea side 14 from the lake side 12, and therefore, is more excellent than tidal power generation in a single flow flooding type, which generates electricity only when seawater flows into the lake side from the sea side, in respect to the operational rate of power facilities.

To transmit electricity from the ocean current generators 120 in the lake side and the ocean current generators 220 in the sea side to a substation, the electricity may be transmitted to a substation within the tidal power plant 100 through a cable under the sea or may be transmitted directly to a substation on land.

When the turbine generators 110 of the tidal power plant 100 according to the present invention generate electricity, the ocean current generators 120 in the lake side 12 generate electricity. It is preferable that the electricity, which is generated at the ocean current power park of the ocean current generators 120 in the lake side, is sent to the substation within the tidal power plant 100 after increasing the capacity.

Further, if the ocean current generators 120 in the sea side are formed in the generation capacity, which is similar to the sum of electricity produced at the ocean current generators 120 in the lake side and the tidal power plant 100, large-scale electricity produced at the ocean current power park of the ocean current generators 220 in the sea side may be connected directly to the substation installed in the tidal power plant 100 without installing additional substations. The reason for this is that the tidal power plant 100 and the ocean current generators 120 in the lake side 12 do not generate electricity when the ocean current generators in the sea side 14 generate electricity at ebbing and all generation capacities of the tidal power plant 100 and the ocean current generators 120, 200 may be received into the substation within the tidal power plant 100.

Ocean currents, which pass through the sluice gates 212 of the tidal power dam 200 and the turbine generators 110 of the tidal power plant 100 according to the present invention, have higher utility value than the natural ocean current condition, and therefore, the ocean current generators 120, 220 in the lake side and sea side can more efficiently produce electricity.

That is, the seawater, which passes through the turbine generators 110 of the tidal power plant 100 and the sluice gates 212 of the tidal power dam 200, is high-quality seawater, which flows in a fixed direction at a predictable speed, and it is easy to control generation volume. Particularly, if a tidal power plant is simultaneously constructed with ocean current power parks, the construction cost could be saved and higher economic effects could be obtained than it is constructed alone.

Moreover, the extraction of kinetic energy of fast ocean currents that pass through the turbine generators of the tidal power plant and the sluice gates of the tidal power dam by the ocean current generators slows down the speed of ocean current, and can relieve a considerable part of the impact on ocean ecosystem and natural environment caused by the tidal power generation. Therefore, ocean current power parks connected with tidal power generation can create a more environmentally-friendly integrated power system capable of complementing the shortcomings of tidal power generation.

In general, to preserve and manage the ocean current generators, the ocean current generators and subsidiary facilities thereof are pulled up to the sea, and may close by a little ship, while the integrated generation system according to the present invention has advantages such that diving or ROV (Remotely Operated Vehicles) may be used for preserving and managing the ocean current generators because flow conditions of ocean currents become more gentle than that of a tidal current plant using the flow of natural tidal currents, due to the existence of barrages, which is constructed at the time of tidal power generation, in the case that generation does not occur or the seawater is not discharged.

The present invention has been described above in relation to several example embodiments shown in the drawings, but should not be considered as limited to the embodiments. Rather, those skilled in the art will recognize that various changes in the details of these embodiments can be made without departing from the scope of the invention.

1. An integrated power system combining tidal power generation and ocean current power generation, comprising:
constructing barrages across the sea to make up a lake;
installing turbine structures of a tidal power plant 100 and sluice structures of a tidal power dam, for generating electricity by using the potential energy difference between seawaters caused by tides and ebbs, between the barrages;
installing turbine generators, for generating electricity by rotating turbine blades, using flow of the incoming seawater within the turbine structures;
installing sluice gates, for closing and opening sluice conduits when flooding and ebbing, in the sluice structures; and
forming an ocean current power park by installing a plurality of ocean current generators, for generating electricity, using the flow of seawater discharged through the turbine generators, in the rear of the turbine structures of the tidal power plant.

2. An integrated power system combining tidal power generation and ocean current power generation, comprising:
constructing barrages across the sea to make up a lake;
installing turbine structures of a tidal power plant and sluice structures of a tidal power dam, for generating electricity by using the potential energy difference between seawaters caused by tides and ebbs, between the barrages;
installing turbine generators, for generating electricity by rotating turbine blades by using the flow of the incoming seawater within the turbine structures;
installing sluice gates, for closing and opening sluice conduits when flooding and ebbing, in the sluice structures; and
forming an ocean current power park by installing ocean current generators, for generating electricity by using the seawater flow with the fast speed discharged through the sluice gates, in the rear of the sluice structures of the tidal power dam.

3. An integrated power system combining tidal power generation and ocean current power generation, comprising:
constructing barrages across the sea to make up a lake;
installing turbine structures of a tidal power plant and sluice structures of a tidal power dam, for generating electricity by using the potential energy difference between seawaters caused by tides and ebbs, between the barrages;
installing turbine generators, for generating electricity by rotating turbine blades, using the flow of the incoming seawater within the turbine structure;
installing sluice gates, for closing and opening sluice conduits when flooding and ebbing, in the sluice structures; and
forming an ocean current power park by installing a plurality of ocean current generators, for generating electricity, using the flow of seawater discharged through the turbine generators, in the rear of the turbine structures of the tidal power plant, and an ocean current power park by installing ocean current generators, which generate electricity, using the flow of seawater with the fast speed discharged through the sluice gates, in the rear of the sluice structures of the tidal power dam.

4. The integrated power system according to claim 1, wherein the plurality of ocean current generators installed in the rear of the turbine structures of the tidal power plant arranged in a cross shape with a predetermined space between lines and the ocean current generators in even number line and odd number line are arranged to be cross each other.

5. The integrated power system according to claim 3, wherein the plurality of ocean current generators installed in the rear of the turbine structures of the tidal power plant arranged in a cross shape with a predetermined space between lines and the ocean current generators in even number line and odd number line are arranged to be cross each other.

6. The integrated power system according to claim 2, wherein the plurality of ocean current generators installed in the rear of the sluice structures of the tidal power dam are arranged in cross shape with a predetermined space between lines and the ocean current generators in even number line and odd number line are arranged to be cross each other.

7. The integrated power system according to claim 3, wherein the plurality of ocean current generators installed in the rear of the sluice structures of the tidal power dam are arranged in cross shape with a predetermined space between lines and the ocean current generators in even number line and odd number line are arranged to be cross each other.

8. The integrated power system according to claim 1, wherein the plurality of ocean current generators installed in the rear of the turbine structures of the tidal power plant are installed at a monofile on the sea bed, respectively.

9. The integrated power system according to claim 3, wherein the plurality of ocean current generators installed in the rear of the turbine structures of the tidal power plant are installed at a monofile on the sea bed, respectively.

10. The integrated power system according to claim 2, wherein the plurality of ocean current generators installed in the rear of the sluice structures of the tidal power dam are installed at a monofile on the sea bed, respectively.

11. The integrated power system according to claim 3, wherein the plurality of ocean current generators installed in the rear of the sluice structures of the tidal power dam are installed at a monofile on the sea bed, respectively.

12. The integrated power system according to claim 1, wherein the turbine structures of the tidal power plant and the sluice structures of the tidal power dam are connected to each other with a connection structure therebetween.

13. The integrated power system according to claim 2, wherein the turbine structures of the tidal power plant and the sluice structures of the tidal power dam are connected to each other with a connection structure therebetween.

14. The integrated power system according to claim 3, wherein the turbine structures of the tidal power plant and the sluice structures of the tidal power dam are connected to each other with a connection structure therebetween.

15. The integrated power system according to claim 1, wherein the turbine structures of the tidal power plant and the sluice structures of the tidal power dam are connected to each other with a connection barrage therebetween.

16. The integrated power system according to claim 2, wherein the turbine structures of the tidal power plant and the sluice structures of the tidal power dam are connected to each other with a connection barrage therebetween.

17. The integrated power system according to claim 3, wherein the turbine structures of the tidal power plant and the sluice structures of the tidal power dam are connected to each other with a connection barrage therebetween.

18. The integrated power system according to claim 1, wherein at least one or more turbine structures of the tidal power plant and sluice structures of the tidal power dam are connected each other, respectively.

19. The integrated power system according to claim 2, wherein at least one or more turbine structures of the tidal power plant and sluice structures of the tidal power dam are connected each other, respectively.

20. The integrated power system according to claim 3, wherein at least one or more turbine structures of the tidal power plant and sluice structures of the tidal power dam are connected each other, respectively.
